(19) United States
(12) Patent Application Publication
(10) Pub. No.: US 2025/0055029 A1
(43) Pub. Date: Feb. 13, 2025

(54) CROSSLINKED SOLID ELECTROLYTE

(71) Applicant: IFP Energies nouvelles, RUEIL-MALMAISON (FR)

(72) Inventors: Niki HALTTUNEN, RUEIL-MALMAISON CEDEX (FR); Mona Marie OBADIA, RUEIL-MALMAISON CEDEX (FR)

(21) Appl. No.: 18/720,293

(22) PCT Filed: Dec. 6, 2022
(86) PCT No.: PCT/EP2022/084547

§ 371 Date: Jun. 14, 2024

(30) Foreign Application Priority Data
Dec. 17, 2021 (FR) 2113908

(51) Int. Cl. H01M 10/0565; C08G 75/045; C08K 5/435; H01M 4/62; H01M 10/0525

(52) U.S. Cl. CPC H01M 10/0565; C08G 75/045; C08K 5/435; H01M 4/62; H01M 10/0525; H01M 2300/0082

(57) ABSTRACT

The present invention relates to a crosslinkable electrolyte formulation comprising at least: —a lithium salt or a mixture of lithium salts—a hydrocarbon molecule comprising two thiol functions—an unsaturated hydrocarbon molecule comprising two C═C double bonds—a crosslinking agent, said crosslinking agent being a molecule carrying at least three C═C double bonds; in which the [C═C double bond]/[thiols] molar ratio is of between 1 and 1.1. The invention also relates to a process for the preparation of a crosslinked solid electrolyte by means of said formulation, and also to the use of said crosslinked solid electrolyte as solid electrolyte of an all-solid-state Li-ion battery or as component of the positive (posolyte or catholyte) or negative (negolyte or anolyte) electrode of an electrochemical system.

### TECHNICAL FIELD

The invention relates to the preparation of crosslinked solid electrolytes for lithium-ion batteries based on thiol-ene reactions.

### PRIOR ART

The reaction used in the invention (thiol-ene reaction) has applications in many fields, including batteries.

The thiol-ene (also alkene hydrothiolation) reaction is a reaction between a thiol and an alkene to form a thioether. This reaction was reported for the first time in 1905 but it assumed importance in the late 1990s and early 2000s for its feasibility and its wide range of applications, in particular for electrolytes.

Thiols are excellent nucleophiles through the formation of thiolate anions (RS⁻) and are also electrophiles via thiyl radicals (RS*). One of the most studied reactions involving thiols is the hydrothiolation of (C═C) double bonds. Depending on the nature of the substituents of the double bond, i.e. electron donors or acceptors, and the type of catalyst employed, the thiol-C═C reaction can take place according to a radical or nucleophilic mechanism.

In the case of a nucleophilic mechanism, the reaction is the Michael addition to a double bond substituted by an electron-withdrawing group, such as (meth)acrylates (monomers containing an active double bond), and a nucleophilic base is used as catalyst.

In the case of a radical mechanism, it is important to avoid electron-withdrawing substituents (monomers containing an active double bond) in order to be free from the polymerization of unsaturated entities and from uncontrolled side reactions. Nonactivated monomers, such as allyl or vinyl ethers, are preferably used. The hydrothiolation can then be initiated thermally or photochemically.

Xuan et al. (2020), Journal of Power Sources, Vol. 456, p. 228024. DOI: 10.1016/j.jpowsour.2020.228024, use a thiol of (2,2′-(ethylenedioxy)diethanethiol) type, which they react with an acrylate function, without crosslinking agent. The polymers obtained are viscous liquid polymers. The conductivity values described at 25° C. correspond to those of materials which are poorly crosslinked under equivalent conditions.

Sarapas et al., Macromolecules, 2016, 49, 4, 1154-1162, use vinyl and thiol monomers for the growth of their chains, but without crosslinking. The conductivities described at 80° C. are relatively low.

The publication ACS Macro Lett., 2020, 9, 500-506, describes a (2,2′-(ethylenedioxy)diethanethiol) combined with an allyl ethylene glycol, in association with pentaerythritol tetrakis(mercaptopropionate) as crosslinking agent. Nevertheless, the values of conductivities measured remain low.

The patent applications US2019237803 AA and US20411906 AA describe networks formed from the thiol-ene reaction in an aqueous medium. The electrolyte obtained is a polymer gel (that is to say, a material trapping a large amount of liquid), necessarily comprising water. The examples relate only to gels containing solvents. The Faraday efficiencies (charging/discharging of the battery) described are very low (around 80%).

The patent application US2021057753 AA describes an anode for an electrochemical cell comprising an electroactive material comprising lithium and a porous protective layer comprising a polymer based on thiols. The polymer is used as an additive or layer for protection of an electrode, but not as an electrolyte.

Surprisingly, the applicant company has noticed that, in nonaqueous formulations of solid electrolytes, crosslinking improved the mechanical properties of the network compared with the use of homopolymers, and that the use of a hydrocarbon molecule carrying two thiol functions in association with an unsaturated hydrocarbon molecule comprising two C═C double bonds in the presence of a crosslinking agent, in which the [C═C double bond]/[thiols] molar ratio in the formulation is of between 1 and 1.1, made it possible to increase the resistance of the network to chemical degradation.

In particular, it appears that three organic molecules: triethylene glycol divinyl ether, trivinylcyclohexane, and 2,2′-(ethylenedioxy)diethanethiol, can be used as solid electrolyte of an all-solid-state Li battery or as component of the positive electrode (posolyte or catholyte), including a lithium salt to ensure good transportation of the lithium ions in the electrolyte and the catholyte. The electrolyte formulation according to the invention makes it possible in particular to obtain conductivities of several orders of magnitude greater than those obtained in the prior art (10⁻⁵ to 10⁻⁷ S/cm).

### SUMMARY OF THE INVENTION

The crosslinkable electrolyte formulation according to the invention comprises at least:
a lithium salt or a mixture of lithium salts;
a hydrocarbon molecule comprising two thiol functions;
an unsaturated hydrocarbon molecule comprising two C═C double bonds;
a crosslinking agent, said crosslinking agent being a molecule carrying at least three C═C double bonds;
in which the [C═C double bond]/[thiols] molar ratio is of between 1 and 1.1.

The amount of lithium salt(s) can represent between 2% and 40% by weight, with respect to the total formulation weight, preferably between 10% and 30% by weight, with respect to the total formulation weight.

The amount of crosslinking agent can be of between 0.5% and 20% by weight, preferably between 1% and 5% by weight, with respect to the total formulation weight.

The crosslinkable electrolyte formulation according to the invention can comprise a radical or anionic initiator, in an amount of between 0.01 and 0.05 times the total formulation weight excluding lithium salt(s).

The crosslinkable electrolyte formulation according to the invention can comprise a chain terminator which makes it possible to generate pendant chains, said chain terminator being a molecule carrying a single C═C double bond, without labile protons, in an amount strictly less than the amount of material of the crosslinking agent, preferably a molecule comprising ether or poly(ethylene glycol) functions, very preferably a vinyl ethyl ether or a vinyl methyl ether. The crosslinking agent can be chosen from 1,2,4-trivinylcyclohexane, diallyl maleate, 1,3,5-triallyl-1,3,5-triazine-2,4,6(1H,3H,5H)-trione, 2,4,6-triallyloxy-1,3,5-triazine, pentaerythritol allyl ether, pentaerythritol triallyl ether, trimethylolpropane allyl ether, glyoxal bis(diallyl ether), trimethylolpropane tri(meth)acrylate, pentaerythritol tri(meth)acrylate, trimethylolpropane ethoxylate tri(meth)acrylate, glycerol propoxylate (1 PO/OH) tri(meth)acrylate, trimethylolpropane propoxylate tri(meth)acrylate, pentaerythritol tetra(meth)acrylate, di(trimethylolpropane) tetra(meth)acrylate, very preferably from 1,2,4-trivinylcyclohexane, 2,4,6-triallyloxy-1,3,5-triazine, pentaerythritol allyl ether, trimethylolpropane allyl ether; more preferably still, the crosslinking agent is 1,2,4-trivinylcyclohexane.

The hydrocarbon molecule comprising two thiol functions can be 2,2′-(ethylenedioxy)diethanethiol.

The hydrocarbon molecule comprising two C═C double bonds can be chosen from oligoethylene glycols carrying two C═C bonds, diallyl ethers and diacrylates or dimethacrylates, preferably is triethylene glycol divinyl ether.

The crosslinkable electrolyte formulation according to the invention can comprise a plasticizer of the oligoethylene glycol, nonaqueous solvent of low volatility or ionic liquid type, said plasticizer representing less than 15% by weight, with respect to the total formulation weight.

The invention also relates to a process for the preparation of a crosslinked solid electrolyte, in which:
a) the crosslinkable electrolyte formulation according to any one of the alternative forms which are described is crosslinked, in the optional presence of a nonaqueous solvent, by means of a radical or anionic initiator added to or already present in the formulation and by thermal or photoinduced activation, in order to form a polymer which conducts lithium ions,
b) the optional solvent present in said polymer is evaporated in order to obtain a crosslinked solid electrolyte.

The photoinduced activation can be carried out by UV lamp or stereolithography.

The invention also relates to the use of the crosslinked electrolyte obtained by crosslinking of the formulation according to any one of the alternative forms which are described or obtained by the process for the preparation of a crosslinked electrolyte according to any one of the alternative forms which are described as solid electrolyte of an all-solid-state Li-ion battery or as component of the positive (posolyte or catholyte) or negative (negolyte or anolyte) electrode of an electrochemical system.

### LIST OF THE FIGURES

FIG. 1 represents the conductivity (S/cm) as a function of the temperature (1000/T with T in K) of the preparations A1-3 (according to the invention) and P1 (comparative) in example 1.

FIG. 2 represents the conductivity (S/cm) as a function of the temperature (1000/T with T in K) of the formulations B1 (according to the invention) and P1 (comparative) in example 2.

FIG. 3 represents the conductivity (S/cm) as a function of the temperature (1000/T with T in K) of C1 (according to the invention) and P1 (comparative) in example 3.

### DESCRIPTION OF THE EMBODIMENTS

The invention relates to a crosslinkable electrolyte formulation comprising:
a lithium salt or a mixture of lithium salts;
a hydrocarbon molecule carrying two thiol functions;
an unsaturated hydrocarbon molecule comprising two C═C double bonds;
a crosslinking agent;
optionally a plasticizer of the oligoethylene glycol, nonaqueous solvent of low volatility (vapor pressure less than 8 kPa at 20° C.) or ionic liquid type, said plasticizer representing less than 15% by weight, with respect to the total formulation weight.

The crosslinkable electrolyte formulation according to the invention can contain a radical or anionic initiator in order to initiate the polymerization/crosslinking reaction subsequently. In an alternative form, the radical or anionic initiator can be added to the formulation according to the invention during the polymerization/crosslinking reaction.

The formulation obtained can be crosslinked by any technique known to a person skilled in the art.

In the electrolyte formulation according to the invention, the [C═C double bond]/[thiols] molar ratio is advantageously between 1 and 1.1, preferably strictly greater than 1.

In particular, the invention can employ the combination of three organic molecules: 2,2′-(ethylenedioxy)diethanethiol, triethylene glycol divinyl ether and trivinylcyclohexane, as crosslinking agent, in the presence of a lithium salt or of a mixture of lithium salts.

The electrolyte obtained by crosslinking can be used as solid electrolyte of an all-solid-state Li battery or as component of the positive or negative electrode (posolyte or catholyte, negolyte or anolyte), and including a lithium salt in order to provide good transportation of the lithium ions in the electrolyte and the catholyte/anolyte.

In one embodiment, a compound of chain terminator type can also be added to the crosslinkable electrolyte formulation according to the invention to create pendant chains during the crosslinking.

In order to obtain a crosslinked solid electrolyte according to the invention, the crosslinkable mixture comprising the following three molecules: hydrocarbon molecule carrying two thiol functions, unsaturated hydrocarbon molecule comprising two C═C double bonds and crosslinking agent, is brought into contact with a lithium salt and optionally a nonaqueous solvent, then the crosslinking reaction is triggered by means of an initiator (radical or anionic initiator) by any technique known to a person skilled in the art. The crosslinking reaction can be initiated in particular by thermal or photoinduced activation.

On conclusion of the reaction, a polymer which conducts lithium ions is formed; this polymer may contain a trapped solvent if a solvent is present in the formulation, which can subsequently be evaporated in order to obtain a solid material.

In the electrolyte formulations according to the invention, the thiol/double bond ratio is generally stoichiometric or in a slight excess of C═C double bonds; on the other hand, an excess of thiol is not desirable.

The composition of the formulation can be modified by varying the amount of crosslinking agent and, if appropriate, of monomer forming the pendant chains. The amount of lithium salt and also of radical or anionic initiator can also be modified and a plasticizer can be added.

In summary, the crosslinked solid electrolytes according to the invention comprise at least:
a molecule carrying 2 C═C double bonds, advantageously chosen from oligoethylene glycols carrying two C═C bonds (for example divinyls, such as triethylene glycol divinyl ether, which is the most commercially available molecule, diallyl ethers, diacrylates or dimethacrylates);
a molecule carrying two thiol functions (2,2′-(ethylenedioxy)diethanethiol, for example);
a lithium salt or a mixture of lithium salts: any lithium salt soluble in the resin formed (LiPF₆, LiFSI (lithium bis(fluorosulfonyl)imide), LiCIO₄, and the like) or a mixture of several soluble lithium salts may be suitable.

LiFSI (lithium bis(fluorosulfonyl)imide) and LiTFSI (lithium bis(trifluoromethanesulfonyl)imide) are preferred due to their good properties of conductivity and of electrochemical stability. The amount of lithium salt or of mixture of lithium salts preferably varies between 2% and 40% by weight, with respect to the total formulation weight; for example, a content of 20% by weight can be used;
a crosslinking agent: any molecule carrying at least three carbon-carbon C═C double bonds can be used as crosslinking agent for the crosslinkable electrolyte formulation according to the invention (for example, trivinylcyclohexane or other molecules described below, in particular of at least trivalent thiols type), advantageously at a content of between 0.5% by weight and 20% by weight, with respect to the total formulation weight, very preferably between 1% and 15% by weight, more preferably still between 1% and 5% by weight;
optionally, a compound having the function of chain terminator (ethyl vinyl ether in the examples), making it possible to generate pendant chains, can be added to the formulation: any molecule carrying a single C═C double bond may be suitable but the presence of ether or poly(ethylene glycol) functions is desirable. The molecule chosen must not comprise labile protons and the amount of material of the chain terminator is advantageously strictly less than the amount of material of the crosslinking agent.

In the crosslinkable electrolyte formulation according to the invention, the ratios between the different components are chosen according to precise criteria which make it possible to obtain improved rheological and conductivity properties. In particular, the ratios between crosslinking agent, molecule carrying two C═C double bonds, molecule carrying two thiol functions and chain terminator are calculated in the following way:
the [C═C double bond]/[thiols] molar ratio must be between 1 and 1.1; an excess of thiols is not desirable.

Optionally, a plasticizer chosen from oligoethylene glycols, nonaqueous solvents of low volatility of carbonates or polyethers type or ionic liquids can be added to the formulation. The plasticizer must make up less than 15% by weight, with respect to the total formulation weight.

The radical or anionic initiator, preferably radical initiator (AIBN and TPO in the examples), makes it possible to initiate the crosslinking reaction.

The initiator can be activated thermally (for example compound of diazo or peroxide type) or by UV radiation. Any initiator known to a person skilled in the art, in particular any commercial initiator, can be chosen.

The amount of initiator to be used advantageously represents between 0.01 and 0.05 times the weight of the mixture of crosslinkable reactants (that is to say, the weight of the formulation without the lithium salt(s), without plasticizer and without optional solvent); the choice of the exact amount is adjusted by a person skilled in the art.

Nature of the crosslinking agent:

Any molecule carrying at least three carbon-carbon double bonds can serve as crosslinking agent.

The crosslinking agent which can be used in the formulations according to the invention can in particular be chosen from the following list:

1,2,4-trivinylcyclohexane, diallyl maleate, 1,3,5-triallyl-1,3,5-triazine-2,4,6(1H,3H,5H)-trione, 2,4,6-triallyloxy-1,3,5-triazine, pentaerythritol allyl ether, pentaerythritol triallyl ether, trimethylolpropane allyl ether, glyoxal bis(diallyl ether), trimethylolpropane tri(meth)acrylate, pentaerythritol tri(meth)acrylate, trimethylolpropane ethoxylate tri(meth)acrylate, trimethylolpropane tri(meth)acrylate, glycerol propoxylate (1PO/OH) tri(meth)acrylate, trimethylolpropane propoxylate tri(meth)acrylate, pentaerythritol tetra(meth)acrylate, di(trimethylolpropane) tetra(meth)acrylate.

The preferred compounds meet the following criteria:
they do not carry labile protons (such as pentaerythritol triallyl ether),
they do not have easily hydrolyzable functions (esters or amides),
they carry 3 or more carbon-carbon double bonds.

Preferably, the crosslinking agent can be chosen from 1,2,4-trivinylcyclohexane, 2,4,6-triallyloxy-1,3,5-triazine, pentaerythritol allyl ether or trimethylolpropane allyl ether.

Very preferably, the crosslinking agent can be 1,2,4-trivinylcyclohexane. This molecule exhibits in particular the advantage of being commercially available and it does not exhibit hydrolyzable functions (ester, amide, and the like) which might possibly weaken the network. The crosslinking agent can also be a polyvalent, at least trivalent, thiol.

The activation of the crosslinking can be done after addition of the radical or anionic initiator, or by employing the radical or anionic initiator already present in the formulation by photoinduction or by thermal activation.

Photoinduction can be done by means of a UV lamp or stereolithographic techniques, in particular laser, LCD screen, 3D printing (also called additive manufacturing). The invention can be applied in particular to the 3D printing of batteries, in particular batteries for vehicles.

In the case where the solid electrolyte is in contact with the positive electrode, the crosslinkable formulation according to the invention in the liquid state can be coated on a positive electrode preprepared according to the protocols of a person skilled in the art in order for the liquid formulation to wet the porosity of the electrode. Finally, crosslinking is obtained after thermal initiation or photoinitiation (UV).

In an alternative form of the invention, the formulations according to the invention can be used to formulate a positive electrode (cathode) ink, by adding in particular to the formulation the active material (for example a lithiated nickel-manganese-cobalt mixed oxide or a lithiated iron phosphate) and the electronic percolant. This ink, once coated and dried, can constitute a solid positive electrode.

### Characterization Techniques

The ionic conductivity of an electrolyte is measured in S/cm and characterizes the ability of the electrolyte to transport ions.

The ionic conductivity of the electrolyte is measured by electrochemical impedance spectroscopy in a Biologic® CESH cell. The measurement is carried out at several temperatures using a thermostatically controlled Biologic® ITS chamber. The impedance spectrum is acquired using a Biologic® MTZ 35 potentiostat between 30 MHz and 0.1 Hz around 0 V and with an amplitude of ±10 mV. The conductivity value can be determined by adjustment of the curve with an equivalent circuit of the (R1+R2//CPE1+CPE2) type or visually by taking the value of the real part of the impedance Re(Z) at the minimum reached by the curve between the semicircle and the halfline corresponding to the capacitive part on the Nyquist diagram.

The cation transport number (t+) corresponds to the fraction of the total conductivity related to the transport of charges by the cations and is characterized by impedance spectroscopy on a sample mounted between two nonblocking electrodes (made of lithium metal) at 60° C. with a Biologic VMP3 potentiostat between 1 MHz and 0.1 MHz around 0 V with an amplitude of 10 mV. The transport number is obtained by adjustment of an equivalent circuit (R1+R2//CPE2+R3//CPE3+Wd1) and then by application of the formula: t+=R₂/(R_{Wd1}+R₂). This measurement method corresponds to the “Watanabe” method (Solid State Ionics, 28-30 (1988), 911-917).

The solvent swelling test and the calculation of the soluble fraction are conventional methods of characterization of polymer networks in order to have an indirect assessment of their crosslinking density and also of their chemical stability. After immersion of approximately 300 mg of polymer network sample in a large excess of chloroform (CHCl₃) at ambient temperature for 72 hours, the swollen samples are weighed and subsequently vacuum dried.

The soluble fraction (ws) is calculated with the following equation:

$$ws = 1 - {w}_{d} / {w}_{0}$$

with w₀ the initial weight of the sample swollen with solvent (estimated by linear regression on the curve of the weights measured at regular intervals of 0.5 to 5 minutes after having removed the sample from the solvent) and w_{d} the weight of the sample after extraction of the soluble fraction and drying.

The degree of swelling, which corresponds to the gain in volume of the network after immersion in the solvent, (1/q2) is calculated with the following equation:

$$1 / q 2 = {ρ}_{p} ( q 1 - 1 ) / {ρ}_{s}$$

where q1 is the ratio of the weight of swollen sample to the weight of dry sample, ρₛ is the density of the solvent (ρₛ=1.492 g·cm⁻³ for CHCl₃) and ρ_{ρ} is the density of the polymer network.

### Advantages of the Invention

The crosslinkable electrolyte formulation according to the invention exhibits the advantage, in particular in comparison with prepolymerized polymers, of being liquid at the start, which makes it possible to obtain good cohesion at the interfaces with the electrodes, in particular due to easier filling of the porosity of the materials.

The use of controlled crosslinking on a mixture of particular monomers and the particular morphology of the three-dimensional network furthermore confer increased mobility on the chains and consequently improved ionic conduction. The performance qualities of the solid electrolyte according to the invention are based in particular on the specific choice of certain monomers which are very flexible and good solvents for lithium ions and on a controlled crosslinking.

The rheological behavior obtained for the samples of crosslinked electrolyte according to the invention advantageously corresponds to that of a crosslinked polymer.

### EXAMPLES

In order to simplify the notation, the following components of the formulation according to the invention in examples 1 to 3 below are subsequently named:
1,2,4-trivinylcyclohexane: TVCH
2,2′-(ethylenedioxy)diethanethiol: EDDT
triethylene glycol divinyl ether: TEGDVE
ethyl vinyl ether: EVE

### Example 1

A crosslinked electrolyte precursor is prepared according to the crosslinkable electrolyte formulation of table 1. Three formulations of identical composition are prepared and are denoted A1, A2 and A3. The composition of the mixture in table 1 (composition of the samples A1-3) is expressed in percentages by weight. The mixture is subsequently crosslinked between a Teflon® plate and a glass plate by UV illumination with a Delolux A2 365 nm lamp, with a power of 300 to 600 mW/cm², until a solid product is obtained, typically from 30 seconds to 3 minutes. The electrolyte is elastic and adheres to the glass. A sample is also prepared by impregnating a Celgard® battery separator with the liquid precursor, then by crosslinking of the mixture under UV radiation; this sample is used for the measurement of the transport number.

TABLE 1

| Component | Amount (% w) |
|---|---|
| LiTFSI | 20 |
| EDDT | 38.4 |
| TEGDVE | 40.8 |
| TVCH | 0.8 |
| TPO* | 0.8 |

*the weight of radical initiator TPO is added last and represents 1% of the weight of the crosslinkable mixture (excluding LiTFSI); it is not included in the % by weight of the other components

Three reference samples based on PEO (poly(ethylene oxide)) [p(EO)] with a molar mass of 300 kDa and on LiTFSI (lithium bis(trifluoromethanesulfonyl)imide) with an EO/Li ratio of 20 are prepared. For each sample, the polymer and the LiTFSI are dissolved in acetonitrile, the liquid is poured into a Teflon® mold and the acetonitrile solvent is evaporated. Each sample is denoted P1.

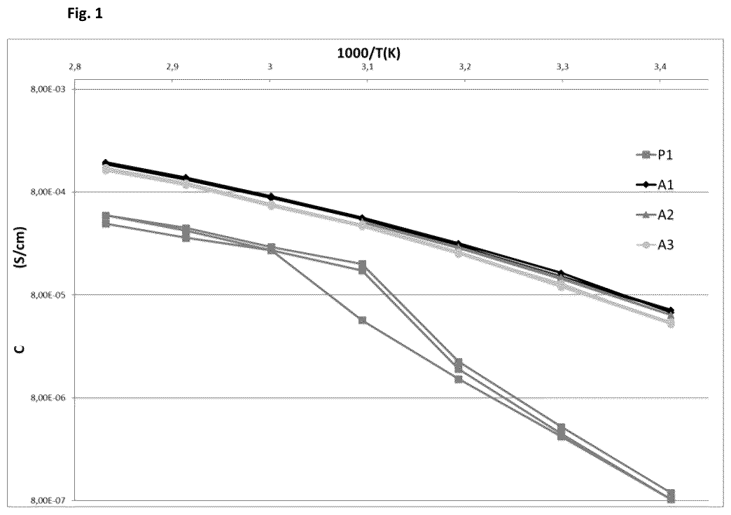

The ionic conductivity of the electrolyte is measured by impedance spectroscopy in a Biologic® CESH cell. The measurement is carried out at several temperatures using a thermostatically controlled Biologic® ITS chamber. The impedance spectrum is acquired using a Biologic® MTZ 35 potentiostat between 30 MHz and 0.1 Hz around 0 V and with an amplitude of 10 mV. The sample P1 is characterized in the same way and serves as reference. The conductivity data are compared with those of the sample P1 and are presented in FIG. 1. It is noticed, in this figure, that the conductivity of the samples A1, A2 and A3 is greater than the conductivity of the samples P1 over the entire temperature range.

The transport number of the samples is measured by impedance spectroscopy. The electrolytes are positioned between two lithium metal electrodes and characterized at 60° C. The impedance spectrum is acquired via a Biologic® VMP3 potentiostat at 0 V with an amplitude of 10 mV between 1 MHz and 0.1 MHz. The impedance spectrum is adjusted by an equivalent circuit and the electrolyte and diffusion resistances can then be extracted. The transport number is calculated from these resistances. The transport number is measured on the sample A1 and the value obtained is 0.14.

The crosslinking of the sample A1 is confirmed by measuring the swellings and the insolubles content of the electrolyte. The measurement is carried out by saturation of a sample of known weight with chloroform for 72 hours and then by successive weighings after its removal from the solvent (t+30 s, t+60 s, and the like). These values make it possible to plot a wₛₐₘ=f(t) curve and to go back to the swelling of the sample (w(t₀)/wᵢₙᵢₜ). The sample is subsequently dried under vacuum and the insolubles content is determined (w_{final}/wᵢₙᵢₜ). The swellings observed (15.39) and the insolubles contents of approximately 73.3% show a loose but predominantly crosslinked network (the network containing 20% by weight of LiTFSI not chemically bound to the polymers, an insolubles content <80% is expected for a poorly crosslinked network).

The measurements of conductivity and of transport number show that the electrolyte formulation according to the invention is superior to a reference polymer of PEO-LiTFSI type as regards ionic conductivity while having a transport number similar to that of a PEO in the literature (0.1-0.2 in general, see K. Pożyczka et al., Electrochimica Acta, 227 (2017), 127-135).

### Example 2

The formulation B1 (see table 2, which exhibits the composition of the sample) is prepared in the same way as the formulation of example 1, the main difference being the use of a diazide radical initiator for the crosslinking. The chosen initiator is AIBN and the reaction is triggered by heating at 80° C. for several hours, the mixture being placed in a Teflon® mold for the crosslinking. The results for conductivity, swelling and transport number are obtained in the same way as in example 1.

TABLE 2

| Component | Amount (% w) |
|---|---|
| LiTFSI | 20 |
| EDDT | 39.2 |
| TEGDVE | 36.8 |
| TVCH | 4 |
| AIBN* | 5 |

*the weight of AIBN is added last and represents 5% of the weight of the crosslinkable mixture (excluding LiTFSI); it is not included in the % by weight of the other components

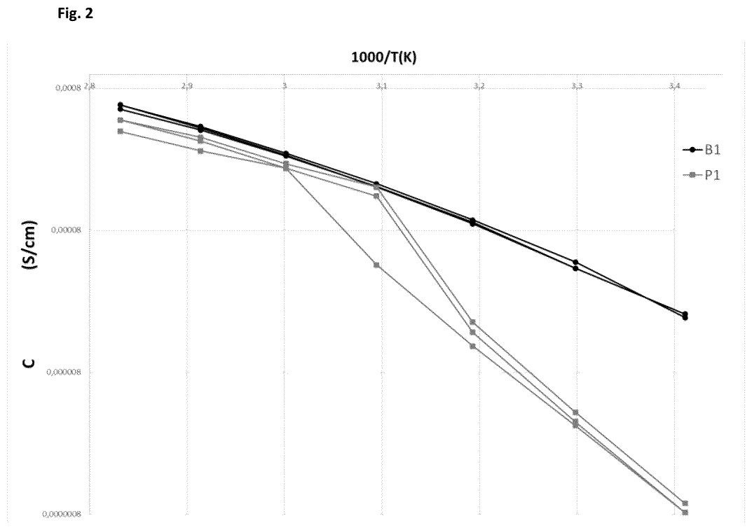

The conductivity data are compared with those of the reference P1 and are presented in FIG. 2. It is noticed that the electrolyte obtained exhibits a slightly better conductivity than the reference P1 at high temperature and a significantly better conductivity at low temperature (T<50° C.), which is an advantage in the field of application of Li-ion batteries. The network exhibits a degree of swelling of 14.97 (i.e. 1497%) and an insolubles content of 69%. These values are similar to those obtained in example 1.

### Example 3

The formulation C1 (table 3, composition of the sample C1) is prepared as described in example 1. This formulation has the distinguishing feature of containing ethyl vinyl ether, which acts as agent for terminating the chains (chain terminator) during the polymerization in order to generate pendant chains in the structure. The samples are characterized in the same way as described in example 1. They are still elastic but less sticky than the films containing only trivinylcyclohexane. The characterizations (ionic conductivity, transport number and swelling) are carried out by the method described in example 1.

TABLE 3

| Component | Amount (% w) |
|---|---|
| LiTFSI | 20 |
| EDDT | 39.8 |
| TEGDVE | 34.7 |
| TVCH | 4 |
| EVE | 1.42 |
| TPO* | 0.8 |

*Same scenario for the TPO as in example 1

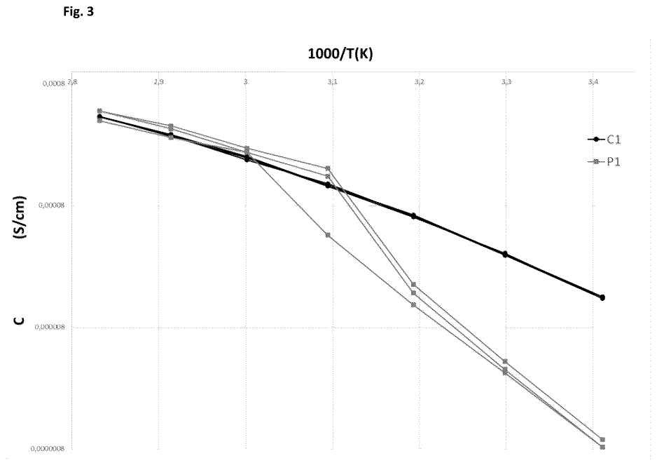

The conductivity data are compared with those of the reference P1 and are presented in FIG. 3.

The ionic conductivity observed (FIG. 3) is slightly lower than that of the formulations A1-3 but it remains greater than or equal to that of the reference sample P1, in particular at low temperature. The transport number is estimated at 0.135 and 0.14 with regard to two measurements carried out on the material. The swelling measured is 12.21 and the insolubles content is 65.2%. The introduction of chain ends results in the presence of “free” polymer chains which are soluble during the swelling test.

1. A crosslinkable electrolyte formulation comprising at least:
a lithium salt or a mixture of lithium salts;
a hydrocarbon molecule comprising two thiol functions;
an unsaturated hydrocarbon molecule comprising two C═C double bonds;
a crosslinking agent, said crosslinking agent being a molecule carrying at least three C═C double bonds;
in which the [C═C double bond]/[thiols] molar ratio is of between 1 and 1.1.

2. The crosslinkable electrolyte formulation as claimed in claim 1, in which the amount of lithium salt(s) represents between 2% and 40% by weight, with respect to the total formulation weight, preferably between 10% and 30% by weight, with respect to the total formulation weight.

3. The crosslinkable electrolyte formulation as claimed in claim 1, in which the amount of crosslinking agent is of between 0.5% and 20% by weight, preferably between 1% and 5% by weight, with respect to the total formulation weight.

4. The crosslinkable electrolyte formulation as claimed in claim 1, comprising a radical or anionic initiator, in an amount of between 0.01 and 0.05 times the total formulation weight excluding lithium salt(s).

5. The crosslinkable electrolyte formulation as claimed in claim 1, comprising a chain terminator which makes it possible to generate pendant chains, said chain terminator being a molecule carrying a single C═C double bond, without labile protons, in an amount strictly less than the amount of material of the crosslinking agent, preferably a molecule comprising ether or poly(ethylene glycol) functions, very preferably a vinyl ethyl ether or a vinyl methyl ether.

6. The crosslinkable electrolyte formulation as claimed in claim 1, in which the crosslinking agent is chosen from 1,2,4-trivinylcyclohexane, diallyl maleate, 1,3,5-triallyl-1,3,5-triazine-2,4,6(1H,3H,5H)-trione, 2,4,6-triallyloxy-1,3,5-triazine, pentaerythritol allyl ether, pentaerythritol triallyl ether, trimethylolpropane allyl ether, glyoxal bis(diallyl ether), trimethylolpropane tri(meth)acrylate, pentaerythritol tri(meth)acrylate, trimethylolpropane ethoxylate tri(meth)acrylate, glycerol propoxylate (1 PO/OH) tri(meth)acrylate, trimethylolpropane propoxylate tri(meth)acrylate, pentaerythritol tetra(meth)acrylate, di(trimethylolpropane) tetra(meth)acrylate, very preferably 1,2,4-trivinylcyclohexane, 2,4,6-triallyloxy-1,3,5-triazine, pentaerythritol allyl ether, trimethylolpropane allyl ether; more preferably still, the crosslinking agent is 1,2,4-trivinylcyclohexane.

7. The crosslinkable electrolyte formulation as claimed in claim 1, in which the hydrocarbon molecule comprising two thiol functions is 2,2′-(ethylenedioxy)diethanethiol.

8. The crosslinkable electrolyte formulation as claimed in claim 1, in which the hydrocarbon molecule comprising two C═C double bonds is chosen from oligoethylene glycols carrying two C═C bonds, diallyl ethers and diacrylates or dimethacrylates, preferably is triethylene glycol divinyl ether.

9. The crosslinkable electrolyte formulation as claimed in claim 1, comprising a plasticizer of the oligoethylene glycol, nonaqueous solvent of low volatility or ionic liquid type, said plasticizer representing less than 15% by weight, with respect to the total formulation weight.

10. A process for the preparation of a crosslinked solid electrolyte, in which:
a) the crosslinkable electrolyte formulation as claimed in claim 1 is crosslinked, in the optional presence of a nonaqueous solvent, by means of a radical or anionic initiator added to or already present in the formulation and by thermal or photoinduced activation, in order to form a polymer which conducts lithium ions,
b) the optional solvent present in said polymer is evaporated in order to obtain a crosslinked solid electrolyte.

11. The process for the preparation of a crosslinked solid electrolyte as claimed in claim 10, in which the photoinduced activation is carried out by UV lamp or stereolithography.

12. The use of the crosslinked electrolyte obtained by crosslinking of the formulation as claimed in claim 1 as solid electrolyte of an all-solid-state Li-ion battery or as component of the positive (posolyte or catholyte) or negative (negolyte or anolyte) electrode of an electrochemical system.
